(19) United States
(12) Patent Application Publication
(10) Pub. No.: US 2024/0302716 A1
(43) Pub. Date: Sep. 12, 2024

(54) SHUTTER AND ELECTRONIC EQUIPMENT COMPRISING AT LEAST ONE OPTICAL SENSOR AND A SHUTTER ASSOCIATED WITH SAID OPTICAL SENSOR

(71) Applicant: SAGEMCOM BROADBAND SAS, Bois-Colombes (FR)

(72) Inventors: Dominique SUSINI, Bois-Colombes (FR); Hugo CHUSSEAU, Bois-Colombes (FR); Arnaud FERREIRA, Bois-Colombes (FR)

(21) Appl. No.: 18/600,163

(22) Filed: Mar. 8, 2024

(30) Foreign Application Priority Data
Mar. 10, 2023 (FR) FR2302262

(51) Int. Cl. G03B 11/04; G06F 1/16; H04N 21/4223; H04N 23/54

(52) U.S. Cl. CPC G03B 11/043; G06F 1/1686; H04N 23/54; H04N 21/4223

(57) ABSTRACT

A shutter includes a plate, a cover having a protection and a strip for handling the protection, the cover being capable of being moved relative to the plate between an active position and an inactive position, at least one male member/female member pair arranged, one on the plate and the other on the cover, such that the engagement of the male member and of the female member temporarily blocks in position the cover in at least one of its two positions. Electronic equipment includes the shutter.

The invention relates to a shutter comprising a plate and a cover engaging with the plate.

The invention also relates to a piece of electronic equipment comprising an optical sensor and such a shutter which temporarily makes it possible to conceal the optical sensor.

### BACKGROUND OF THE INVENTION

Numerous products are equipped with a camera and, in particular, a so-called “webcam” camera, that is a camera which makes it possible to obtain a video, the purpose of which is to be able to be transmitted directly through a network. Mobile phones, tablets, laptops, etc. can thus be mentioned.

However, the user of these products can temporarily wish to conceal the camera.

A conventional solution is to resort to an adhesive cover which can be repositioned, that can be applied in front of the camera.

Such a solution is inexpensive and unobtrusive.

However, it has proved to be particularly visible and can therefore deteriorate the appearance of the product. Furthermore, the adhesive finishes by aging and the cover thus tends to adhere less to the product.

For some time, laptops have been directly equipped with a cover being able to slide between a position, where it conceals the camera and a position where it frees up access to the camera.

Unfortunately, these covers are generally complex and expensive to produce, as they comprise numerous parts.

### AIM OF THE INVENTION

The invention aims for a simplified shutter, which ages better over time. The invention also aims for a piece of electronic equipment equipped with such a shutter.

### SUMMARY OF THE INVENTION

To this end, a shutter is provided, according to the invention, comprising:
A plate,
A cover comprising a protection and a strip for handling the protection, the cover being capable of being moved relative to the plate between an active position and an inactive position,

the shutter comprising at least one male member/female member pair arranged one on the plate and the other on the cover, such that the engagement of the male member and of the female member temporarily blocks in position the cover in at least one of its two positions,

wherein the protection comprises a first main face and a second main face, at least one male member or one female member of the pair being arranged on one of said main faces of the protection.

Thus, the shutter comprises simply two components which engage between them, to ensure a blocking of the cover in position.

The invention has thus proved to be simple in structure and relatively inexpensive to produce.

Furthermore, it is more aesthetic than devices of the prior art, in particular, adhesive-based devices which can be repositioned.

Moreover, the engagement between the plate and the cover advantageously limits the vibrations of the cover relative to the plate.

This is particularly useful in the case where the shutter is arranged in a piece of electronic equipment which is sensitive to the vibrations, which is, for example, the case of a set-top box, the interfering vibrations of which can deteriorate the sound made by said set-top box.

Optionally, the shutter comprises a first male member/female member pair to block the cover in a first position and a second male member/female member pair to block the cover in a second position.

Optionally, at least one first member—male or female—and at least one second member—male or female—are arranged on one of said main faces of the protection, the first member belonging to the first male/female member pair and the second member belonging to the second male/female member pair.

Optionally, the first member and the second member are arranged on opposite sides of the main face.

Optionally, at least one male member is a raised element and at least one female member is a housing moulding the shape of the raised element.

Optionally, the raised element is partially hemispherical.

Optionally, at least one male member is carried by the plate and at least one female member is carried by the cover.

Optionally, at least one tab is provided on the plate, the tab carrying the male member or the female member of the plate.

Optionally, the tab is a cutout of the plate.

Optionally, the strip is provided with at least one textured zone.

Optionally, the shutter comprises a flexible fastening portion between the protection and the strip.

Optionally, the cover is provided with a visual indicator of at least one of its positions.

Optionally, the member arranged on the main face of the protection is arranged on a face opposite that carrying the visual indicator.

Optionally, the cover comprises at least one lateral notch.

Optionally, the cover comprises at least one guide of its sliding.

Optionally, the plate comprises at least one light guide.

Optionally, the plate comprises at least one positioner.

The invention also relates to a piece of electronic equipment comprising:
A chamber,
An optical sensor arranged in the chamber,
A shutter such as mentioned above, the shutter being arranged such that in its active position, it is in front of the optical sensor and in an inactive position, it is offset from the optical sensor.

Optionally, the equipment is an electronic casing.

Optionally, the equipment comprises a support carrying the optical sensor, the cover being arranged between the chamber and the plate and the plate being arranged between the cover and the support.

Optionally, the equipment is shaped such that in the inactive position of the cover, an orifice of the protection extends into the alignment of an orifice of the chamber and in the alignment of an orifice of the plate. Optionally, the cover is arranged between the chamber and the plate.

Other features and advantages of the invention will emerge upon reading the description below of a particular and non-limiting embodiment of the invention.

### BRIEF DESCRIPTION OF THE DRAWINGS

Reference is made to the accompanying drawings, among which:

FIG. 1 is a schematic, perspective view of a shutter cover according to a particular embodiment of the invention;

FIG. 2 represents the cover illustrated in FIG. 1 according to another orientation;

FIG. 3 is a schematic, perspective view of a plate of the shutter intended to be associated with the cover represented in FIG. 1;

FIG. 4 is a partial, schematic, exploded view of a piece of equipment comprising the cover represented in FIG. 1 and the shutter represented in FIG. 3;

FIG. 5 is a partial, perspective, schematic view of the equipment represented in FIG. 4;

FIG. 6 is a view identical to that of FIG. 5, once the plate is arranged against the cover;

FIG. 7 is a partial, schematic, cross-sectional view of the equipment represented in FIG. 4.

### DETAILED DESCRIPTION OF THE INVENTION

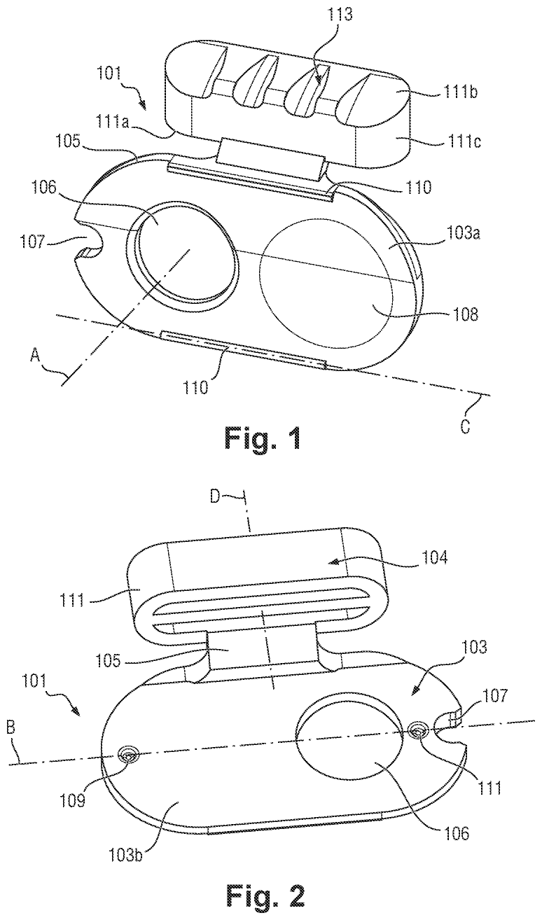

In reference to FIGS. 1 to 3, a shutter 100 is described, according to a particular embodiment of the invention, the shutter 100 intended to be associated with an optical sensor to temporarily conceal it.

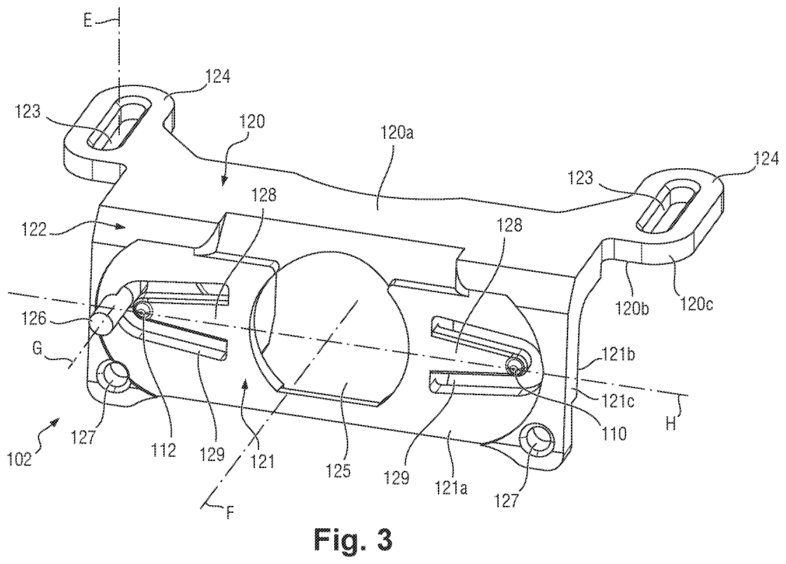

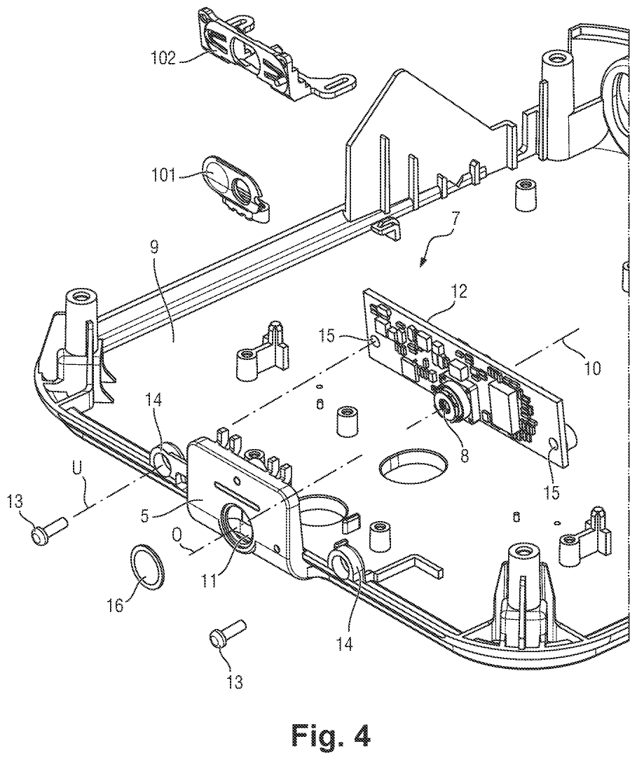

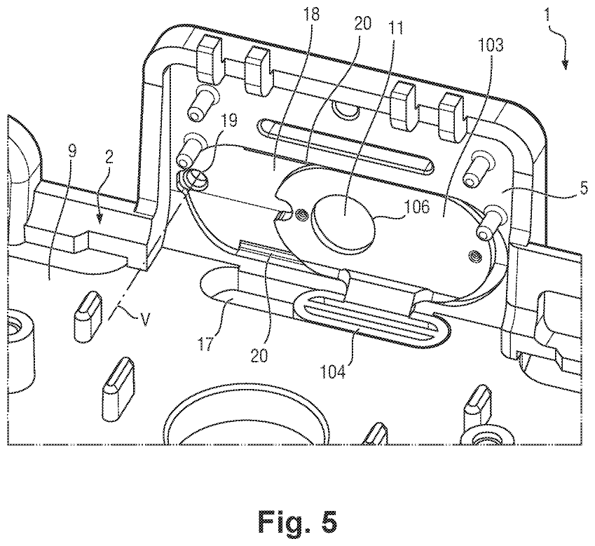

This shutter 100 comprises a cover 101 represented in FIGS. 1 and 2, as well as a plate 102 represented in FIG. 3.

The cover 101 and/or the plate 102 are, for example, made of plastic material. The cover 101 and/or the plate 102 are optionally made by plastic injection. The cover 101 and/or the plate 102 are, for example, made of polycarbonate, made of acrylonitrile butadiene styrene (ABS), etc.

The cover 101 will be the first described.

The cover 101 comprises a protection 103, as well as a strip 104 for handling the protection 103.

The protection 103 is shaped in a platelet. It therefore has a thickness which is thinner than its other dimensions.

The protection 103 comprises, in this case, a first main face 103a and a second main face 103b. The protection 103 comprises, in this case, one single lateral flank 105 connecting the two main faces 103a, 103b together. In this way, the protection 103 does not have a projecting edge.

The protection 103 has, in this case, mainly an oblong-shaped cross-section (normal, an axis A moreover defining the thickness of the protection 103).

The protection 103 comprises at least one orifice 106 passing through it on either side. The orifice 106 extends, in this case, along the axis A. The orifice 106 thus opens onto the two main faces 103a, 103b. Typically, the orifice 106 extends over one of the sides of the protection 103. The orifice 106 has a circular cross-section (normal, the axis A).

Optionally, the protection 103 comprises a notch 107 provided at the lateral flank 105. Said notch 107 is, for example, arranged on the lateral flank 105 next to the orifice 106. The notch 107 however does not open into the orifice 106. However, the notch 107 extends along an axis which is parallel to the axis A. The notch 107 thus opens onto the two main faces 103a, 103b, but also onto the lateral flank 105. The notch 107 has a partially circular cross-section (normal, the axis A).

Preferably, the protection 103 comprises at least one visual indicator 108.

The visual indicator 108 comprises, for example, a geometric shape (such as a circle, a triangle, a rectangle) or at least one alphanumeric symbol or a drawing, etc. which is arranged on the protection. The visual indicator 108 is preferably coloured (orange, white, red, etc.). A diameter of the visual indicator 108 is, for example, equal to or greater than that of the orifice 106.

The visual indicator 108 is arranged on at least one of the main faces 103a, 103b and is, for example, arranged only on the first main face 103a. The visual indicator 108 is more specifically arranged, in this case, next to the orifice 106. Typically, the visual indicator 108 extends over one of the sides of the protection 103 (opposite that where the orifice 106 opens). For example, the visual indicator 108 does not exceed the middle of the main face considered.

The protection 103 comprises at least one female member intended to engage with a male member of the plate 102 which will be described below.

Preferably, the protection 103 comprises a first female member 109 intended to engage with a first male member 110 of the plate 102 and a second female member 111 intended to engage with a second male member 112 of the plate 102. Preferably, the female members 109, 111 are arranged on sides opposite the protection 103 and preferably are arranged on sides opposite the second main face 103b (that is the face opposite that carrying the visual indicator 108).

For example, the first female member 109 is arranged on a first side of the second main face 103b and the second female member 111 is arranged on a second side of said second main face 103b. The second female member 109 is thus arranged closer to the lateral flank 105 than the orifice 106. For example, the second female member 109 is arranged between the orifice 106 and the notch 107.

At least one of the female members 109, 111 is a housing provided in the main face considered. The housing is, for example, partially hemispherically-shaped. The housing is, for example, shaped in a half-sphere. The housing does not open onto the first main face.

Optionally, the two female members 109, 111 are aligned on an axis B which is orthogonal to the axis A. The axis B defines, for example, the length of the main faces 103a, 103b.

Optionally, the orifice 106 and/or the notch 107 are also aligned on said axis B.

The protection 103 is shaped to be able to slide relative to the plate 102 between an active position and an inactive position. The sliding is performed, in this case, along an axis orthogonal to the axis A. The sliding is performed, in this case, parallel to the axis B.

Preferably, the protection 103 comprises at least one guide 110 of its sliding, and preferably at least two guides 110. At least one of the guides 110 is shaped in a rod which extends longitudinally along an axis C. Said axis C is, for example, parallel to the axis B. For example, at least one of the guides 110 is arranged on one of the main faces and preferably on the first main face 103a. The second main face 103b does not comprise such a guide. For example, at least one guide 110 is arranged on a lower or upper edge of the first main face 103a between the two sides of said main face 103a. Preferably, said guide 110 is centred on the first main face (along the axis B). For example, one of the guides 110 is arranged on the upper edge of the first main face 103a and the other on the lower edge, the two guides 110 extending parallel to one another.

The strip 104 comprises a support 111, as well as a portion 112 for fastening the support 111 to the protection 103. The handling strip 104 and the protection 103 are preferably made of one single part. The cover 101 is thus made of one single part.

The support 111 comprises, in this case, a first main face 111a and a second main face 111b. The support 111 comprises, in this case, one single lateral flank 111c connecting the two main faces 111a, 111b to one another. In this way, the support 111 does not have a projecting edge.

The support 111 has, in this case, mainly an oblong-shaped cross-section (normal, an axis D moreover defining the thickness of the support 111).

The fastening portion 112 is shaped, such that the support 111 extends transversally to the protection 103. Thus, the axis D extends transversally to the axis A (i.e. not orthogonally nor parallel).

The fastening portion 112 is preferably flexible and preferably has an elastically deformable performance.

A first main face 111a of the support 111 is thus rotated towards the second main face 103b of the protection 103.

Preferably, the support 111 is shaped so as to have at least one textured zone 113.

This facilitates the handling of the support 111. A finger of a user indeed tends less to slide along the support 111 when the user handles the strip 104 to make the cover 101 slide.

Said textured zone 113 is preferably provided on at least the second main face 111b of the support.

The plate 102 will now be described.

The plate 102 comprises a portion 120 for securing, a portion 121 for engaging and a portion 122 for connecting the engaging portion 121 to the securing portion 120. The three abovementioned portions 120, 121, 122 are preferably made of one single part.

The plate 102 is preferably made of one single part.

The securing portion 120 makes it possible to secure the shutter 100 to an external element such as a piece of electronic equipment.

The securing portion 120 is shaped in a platelet. The securing portion 120 comprises, in this case, a first main face 120a and a second main face 120b. The securing portion 120 comprises, in this case, one single lateral flank 120c connecting the two main faces 120a, 120b to one another. In this way, the securing portion 120 does not have a projecting edge.

The securing portion 120 comprises at least one opening 123 passing through it on either side. Preferably, the securing portion 120 comprises two opening 123 passing through it on either side.

At least one opening 123 extends, in this case, parallel to an axis E (corresponding to that defining the thickness of the securing portion 120). At least one opening 123 thus opens onto the two main faces 120a, 120b of the securing portion 120. Typically, at least one opening 123 extends over one of the sides of the securing portion 120.

At least one opening 123 has an oblong-shaped cross-section (normal, the axis E).

Preferably, an opening 123 is arranged on a first side of the securing portion 120 and an opening 123 is arranged on a second side of the securing portion 120.

For example, the securing portion 120 comprises two arms 124 arranged on each of its sides, each arm 124 being pierced by one of the openings 123.

The engaging portion 121 makes it possible for the plate 102 to engage with the cover 101.

The engaging portion 121 is shaped in a platelet. The engaging portion 121 comprises, in this case, a first main face 121a and a second main face 121b. The engaging portion 121 comprises, in this case, one single lateral flank 121ac connecting the two main faces 121a, 121b to one another. In this way, the engaging portion 121 does not have a projecting edge.

The engaging portion 121 comprises at least one orifice 125 passing through it on either side. The orifice 125 extends, in this case, parallel to an axis F (moreover defining the thickness of the engaging portion 121). The orifice 125 thus opens onto the two main faces 121a, 121b. Typically, the orifice 125 is centred on the main faces 121a, 121b. The orifice 125 has a circular-shaped cross-section (normal, the axis F). The diameter of the orifice 125 is greater than that of the orifice 106.

Optionally, the engaging portion 121 comprises a light guide 126 arranged on one of the sides of the engaging portion 121. Said light guide 126 thus extends through the entire engaging portion 121. A first end of the light guide 126 extends into one same plane as the second main face 121b of the engaging portion 121. A second end of the light guide 126 extends beyond the first main face 121a of the engaging portion 121. The light guide 126 extends along an axis G which is, in this case, parallel to the axis F.

Preferably, the engaging portion 121 comprises at least one positioner 127 to facilitate the positioning of the plate 102 on the external element.

The positioner 127 is presented, for example, in the form of an orifice. For example, the engaging portion 121 comprises two positioners 127, each in the form of an orifice. For example, the orifices are arranged on sides of the engaging portion 121. The orifices extend, so as to open onto each of the main faces 121a, 121b. The orifices extend preferably parallel to the axis F.

As indicated above, the engaging portion 121 comprises at least one male member to engage with one of the female members of the cover 101.

Preferably, the male members 110, 112 are arranged on sides opposite one same main face of the engaging portion 121. The male members are arranged preferably on the first main face 121a. For example, a male member 110 is arranged on a first side of the first main face 121a and a second male member 112 is arranged on a second side of said first main face 121a. For example, the male members 110 and 112 extend from the same first main face as that from which the light guide 126 extends. Optionally, the light guide 126 extends on the side of one of the male members.

At least one of the male members 110, 112 is a raised element. The raised element is, for example, partially hemispherically-shaped. The raised element is, for example, shaped in a half-sphere.

Optionally, the two male members 110, 112 are aligned on an axis H which is orthogonal to the axis F. Optionally, the light guide 126 and/or the orifice 125 are also aligned on said axis H.

Preferably, the engaging portion 121 comprises at least one tab per male member, each tab carrying one of the male members. In the present case, the engaging portion therefore comprises two tabs 128.

Preferably, at least one tab 128 is defined by a cutout of the engaging portion 121. At least one tab 128 thus comprises an end for fastening to the rest of the engaging portion 121 and a free end. The male member 110, 112 is preferably carried by the free end of the tab 128 considered.

Therefore, it is understood that said tab 128 is flexible. For example, the tab 128 has an elastically deformable character.

This is due to the fact that said tab 128 is defined by a cutout in the engaging portion 122.

At least one tab 128 extends longitudinally along an axis parallel to the axis H. Said axis is, in this case, combined with the axis H.

At least one tab 128 is shaped so as to have a tapered cross-section (normal, the axis F) and preferably tapered with a rounded end, the tip forming the free end of the tab 128. For example, the tab 128 is shaped in an isosceles triangle, optionally in an isosceles triangle with a rounded main top, the main top being rounded.

Therefore, it is understood that at least one tab 128 is defined by at least one groove 129 provided in the engaging portion 121, such that the groove 129 opens onto the two main faces 121a, 121b. In the present case, at least one tab 128 is defined by one single groove 129. At least one groove 129 is, for example, horseshoe-shaped, the branches of which are deviated more and more in the direction of their free ends.

The connecting portion 122 is shaped such that the securing portion 120 extends transversally to the engaging portion 121. Thus, the axis F extends transversally to the axis E.

The connecting portion 122 is preferably flexible and preferably has an elastically deformable performance.

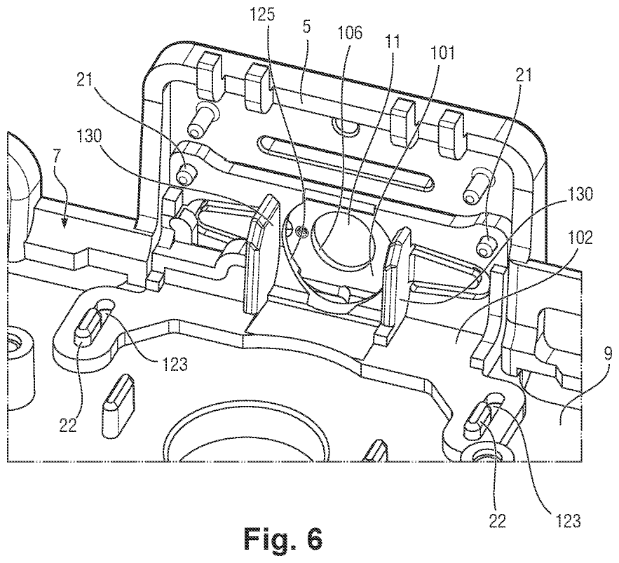

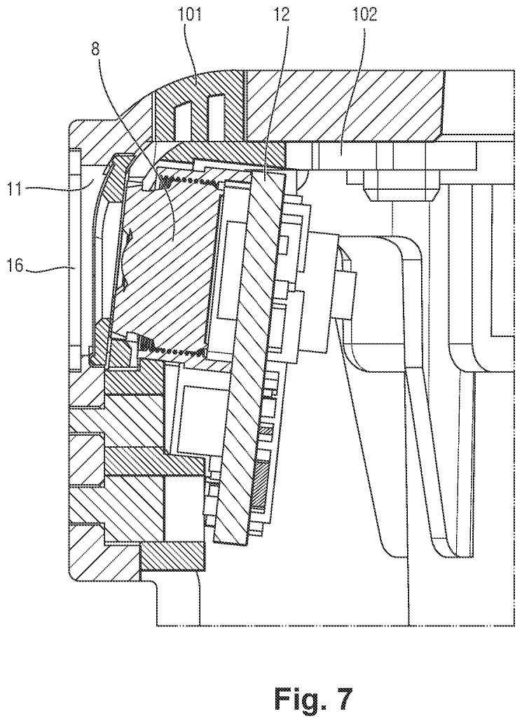

The plate 102 can optionally comprise at least one reinforcement 130 extending between the securing portion 120 and the engaging portion 121 (in particular, between the second main face 120b and the second main face 121b). For example, as illustrated in FIG. 6, the plate 102 comprises at least one first reinforcement 130 and one second reinforcement 130 arranged on either side of the orifice 125. For example, each reinforcement 130 is arranged at the end of fastening of one of the tabs 128 to the rest of the engaging portion 121.

In reference to the different figures, the shutter 100 thus described is therefore shaped to be able to be fixed to a piece of electronic equipment.

The electronic equipment is, for example, an electronic casing and, for example, a set-top box 1.

The set-top box 1 comprises a chamber 2.

Preferably, the chamber 2 is made of at least two parts. For example, the chamber 2 comprises a base and a lid 7, jointly forming the chamber 2.

Preferably, the base and the lid 7 are capable of being interlocked or snap-fitted in one another. Preferably, once the base and the lid 7 are integral with one another, one is fixed to the other by first fixing means comprising, for example, screws.

Moreover, the set-top box 1 comprises an optical sensor 8.

In a manner known per se, the optical sensor 8 has a field of vision (i.e. the viewing zone that the optical sensor 8 can capture during taking an image) which is centred around a line of vision 10 of the optical sensor 8.

The optical sensor 8 is arranged in the set-top box 1 so as to be fixed with respect to the chamber 2.

The optical sensor 8 is, for example, a camera and, for example, a camera comprising an electronic sensor (for example, of the CMOS or CCD type) and at least one optical lens.

The optical sensor 8 is fully arranged inside the chamber 2.

Typically, at least one opening 11 is provided in one of the lateral flanks 5 of the set-top box 1.

The opening 11 therefore extends on the front of the set-top box 1.

The opening 11 extends through the lateral flank 5 rectilinearly along a direction O.

The opening 11 is through, so as to open to a first end inside the chamber 2 and to a second end outside of the chamber 2.

The opening 11 has a cross-section (along a normal cross-sectional plane of the direction O), which is circular, in this case.

The opening 11 has a cross-section which expands in the direction of the outside of the chamber 2.

Thus, the opening 11 is shaped in a cone frustum on at least one section of the opening 11.

The optical sensor 8 is moreover arranged, such that its line of vision 10 extends through the lateral flank 5 from the inside of the chamber 2 to the outside of the chamber 2 by way of said opening 11. The line of vision 10 is naturally an imaginary line, such that it therefore extends virtually through the opening 11.

Moreover, the optical sensor 8 is arranged, such that its line of vision 10 is inclined (i.e. neither parallel nor orthogonal) with respect to a given plane. The given plane is, for example, a plane parallel to an upper main face of the chamber and/or to a lower main face of the chamber. Thus, preferably, said plane is horizontal, when the lower main face rests on a horizontal base.

Subsequently, the line of vision 10 is inclined with respect to the horizontal in the present case.

The line of vision 10 is thus also inclined (and not orthogonal) to the lateral flank 5 wherein the opening 11 is provided.

Optionally, the line of vision 10 is inclined upwards with respect to the plane, wherein the lower main face 3 extends.

Preferably, the direction O wherein the opening 11 axially extends is parallel to the line of vision 10 of the optical sensor. Preferably, the direction O is combined with the line of vision 10 of the optical sensor 8.

Thus, the opening 11 and the field of vision of the optical sensor 8 extend coaxially.

This makes it possible for the opening 11 to avoid interfering with the field of vision.

Preferably, in order to further limit the interferences between the field of vision and the opening 11, the opening 11 is shaped to have a cross-section wider than the corresponding cross-section of the field of vision (for one same normal cross-section plane of the direction O) and this, for at least one section part of the opening 11 (along the direction O) and preferably over the entire length (along the direction O) of the opening 11.

According to a preferred embodiment, the set-top box 1 comprises a support 12 carrying the optical sensor 8. The optical sensor 8 is thus fixed to the support 12. For example, the optical sensor 8 is welded to the support.

Typically, the support 12 is a printed circuit board.

The support 12 is thus shaped in a plate. Its thickness is therefore thinner than its other dimensions. The support 12 thus has two main faces. Said faces are flat. Said faces extend parallel to one another.

The support 12 is itself fixed to the chamber 2 and arranged inside the chamber 2. The support 12 is, for example, fixed to the lid 7. Preferably, the support 12 is fixed to the lid 7 at a main wall 9 of the lid 7 and/or of the lateral flank 5, wherein the opening 11 is provided.

To this end, the set-top box 1 comprises means for fixing the support 12 to the chamber 2. For example, the fixing means comprise at least one screw 13 and the lid 7, at least one corresponding threaded barrel 14, wherein the screw 13 is housed. Preferably, the second fixing means comprise at least two screws 13, each being screwed in service into one of the at least two corresponding threaded barrels 14 of the lid 7.

For example, the support 12 comprises at least one hole 15 passing through it, so as to open to a first end on the first main face of the support 12 and to a second end on the second main face of the support 12, the hole 15 thus extending orthogonally to said faces.

Thus, it suffices to arrange a first screw 13 through one of the holes 15 of the support 12, then in the corresponding barrel 14 of the lid 7 and the second screw 13 through the other hole 15 of the support in the other barrel 14, to fix the support 12 to the lid 7.

At least one of the barrels 14 extends rectilinearly and longitudinally in a direction U. Moreover, at least one of the barrels 14 is arranged, such that when the support 12 is fixed to the lid 7 via the barrels 14, the direction U is orthogonal to the plane, wherein the first main face of the support 12 extends.

According to a particular embodiment, the support 12 is arranged in an inclined manner with respect to the lateral flank 5 carrying the opening 11.

Moreover, the optical sensor 8 is arranged on the first main face of the support 12, such that its line of vision 10 extends orthogonally to said face.

In this way, the optical sensor 8 is actually inclined with respect to the horizontal.

Preferably, a protective window 16 is arranged at the second end of the opening 11 (that is that opening onto the outside).

This makes it possible to protect the optical sensor 8 from the outside environment (dust, for example).

In order to be able to temporarily conceal the field of vision of the optical sensor 8, the shutter 100 is arranged between the chamber 2 and the optical sensor 8.

During a first mounting step, the cover 101 is first arranged in the chamber 2, such that the protection 103 extends to the lateral flank 5 carrying the orifice 11 and that its strip 104 extends to the main wall 9.

The fastening portion 105 is therefore shaped to best mould the junction between the lateral flank 5 and the main wall 9.

Moreover, a hole 17 pierces the main wall 9 so as to open onto an outer face of the main wall 9 on the one hand, and onto an inner face of the main wall 9 on the other hand. The hole 17 extends along a direction V (direction which is parallel to the axis A when the cover 101 is in place). The hole 17 has, for example, an oblong-shaped cross-section (normal, the direction V).

The strip 104 is thus received inside said hole 17 so as to be able to slide along said hole along the axis B which is, in this case, parallel to a direction defining the length or the width of the main wall. Naturally, the shutter 100 is arranged such that its textured zone 113 is accessible by the user from the outside of the chamber 2. The shutter 100 is therefore shaped, such that the second main face 111b is in one same plane as the outer face of the main wall 9 or exceeds it.

Moreover, a reinforcement 18 is provided in the lateral flank 5 (internal side of the chamber 2) to slidingly receive the protection 103. The reinforcement 18 does not open to the outside of the chamber 2.

The reinforcement 18 extends longitudinally in a direction which defines the length or the width of the lateral flank 5.

The reinforcement 18 has a cross-section (normal, the axis A when the protection 103 is in place in the reinforcement 18) of a shape identical to that of the protection 103, but having a length greater than that of the protection 103. The reinforcement 18 therefore has, in this case, an oblong cross-section.

Preferably, the chamber 2 comprises at least one guide 20 to facilitate the sliding of the protection 103 relative to the chamber 2 and preferably at least two guides 20.

At least one of the guides 20 is shaped in a groove extending parallel to the axis C when the cover 101 is in place in the reinforcement 18. At least one groove is thus provided in the reinforcement 18. At least one of the grooves is capable of slidingly receiving at least one of the rods of the protection 103. In the present case, the chamber 2 therefore comprises two grooves extending parallel to one another, one on the upper edge and the other on the lower edge of the reinforcement 18.

Preferably, the chamber is provided with at least one hole 19 passing through the lateral flank 5 on either side. The hole 19 thus extends in a direction parallel to the axis B when the cover 101 is in place in the reinforcement 18. Such a hole 19 thus opens onto the two main faces of the lateral flank 5.

The hole 19 is arranged to enable a user to view, from the outside of the chamber 2, a light signal linked to the optical sensor 8: if the optical sensor 8 is illuminated (and that the user can be filmed), then the light signal makes it possible to indicate it, for example, by emitting a light, for example, red in colour. However, if the optical sensor 8 is switched off, then the light signal also makes it possible to indicate it (for example, by emitting no light).

Advantageously, the notch 107 makes it possible for the cover 101 to not block this hole 19: the user therefore always has access from the outside of the chamber 2 to the light signal, whatever the position of the cover 101 with respect to the chamber 2.

During a second mounting step, the plate 102 is brought back against the cover 101.

Advantageously, the chamber 2 comprises pins 21 being plugged into the positioners 127 which facilitates the correct positioning of the plate 102 relative to the chamber 2.

In the same way, the chamber 2 comprises ridges 22 being plugged into the openings 123 of the securing portion 120.

This facilitates the correct positioning of the plate 102 relative to the chamber 2. A snapping operation (for example hot-snapping) of the ridges 22 then makes it possible to fix the plate 102 to the chamber 2.

In this position, a first face of the plate 102 (defined at least by the first face 120a and the first face 121a) is thus rotated towards the second face of the cover (defined at least by the first face 103b and the second face 111a).

In this position, the cover 101 is thus arranged between the chamber 2 and the plate 102. In this position, the cover 101 is arranged between the chamber 2 and the engaging portion 121 of the plate 102. In this position, the protection 103 is arranged between the chamber 2 and the engaging portion 121 of the plate 102.

The first main face 103a of the protection 103 of the cover 101 is rotated towards the internal main face of the lateral flank 5 and/or is rotated towards the inside of the reinforcement 18.

The second main face 103b of the protection 103 of the cover 101 is rotated towards the main face of the securing portion 120 of the shutter 100. In this way, the members carried by the cover 101 are located opposite the members carried by the shutter 100.

Naturally, the shutter 100 is shaped such that the axis F is parallel to the line of vision 10 of the optical sensor. Preferably, the axis F is combined with the line of vision 10 of the optical sensor 8. Thus, the orifice 125 and the field of vision of the optical sensor 8 extend coaxially. This makes it possible for the orifice 125 to avoid interfering with the field of vision.

Naturally (for each cross-sectional plane, the axis E), the orifice 125 as the orifice 106 both have a diameter at least greater than the diameter of the field of vision. This makes it possible for the orifice to avoid interfering with the field of vision.

Contrary to the plate 102 which is fixed to the chamber 2, the cover 101 can also be moved relative to the chamber 2, but only in its translation movement along the axis B.

During a third mounting step, the support 12 carrying the optical sensor 8 is thus fixed to the lid 7 as indicated above. A part of the optical sensor 8 can optionally extend through the orifice 125 without however exceeding it to enable the cover 102 to be able to slide relative to the plate 101.

In service, when it is sought to film with the optical sensor 8, the cover 101 is in a first position, called inactive position.

In this position, its orifice 106 extends into the alignment of it 11 of the lateral flank 5 (and therefore of that 125 of the plate 102). For example, the orifice 106 is such that the axis A is parallel to the line of vision 10 of the optical sensor. Preferably, the axis A is thus combined with the line of vision 10 of the optical sensor 8. Thus, the orifice 106 and the line of vision of the optical sensor 8 extend coaxially. This makes it possible for the orifice 105 to avoid interfering with the field of vision.

In this position, the shutter 100 makes it possible to ensure the viewing of the light signal, thanks to the alignment of the light guide 126 and of a hole 19. For example, the light guide 126 and the hole 19 extend coaxially to one another and to the axis A. Preferably, the light guide 126 extends until in the hole 19, even extends until the external main face of the lateral flank 5, wherein the hole 19 is provided.

Advantageously, the cover 101 is held in its inactive position, due to the engagement between the first male member 109 and the first female member 110.

When it is sought to block the field of vision of the optical sensor 8, it suffices to make the strip 104 slide (causing the uncoupling between the first male member 109 and the first female member 110) until the second male member 111 is plugged into the second female member 112.

The cover 101 is thus located in its second position (or active position): a solid position of the protection 103 is thus arranged between the opening 11 and the optical sensor 8 blocking the field of vision of it.

Advantageously, the user always sees the light signal associated with the optical sensor 8 thanks to the notch 107 provided in this solid portion and with the hole 19. For example, the notch 107 and the hole 19 extend coaxially to one another.

Also advantageously, the visual indicator 108 can be seen from the outside of the chamber 2 through the opening 11. The user can thus rapidly understand that the field of vision of the optical sensor 8 is concealed.

To move back into the inactive position, it suffices to make the strip 104 slide (causing the uncoupling between the second male member 111 and the second female member 113) until the first male member 109 is plugged again into the first female member 111.

The moving from one position to another of the cover 101 is thus very simple.

It is noted that the engagement of the male/female members makes it possible to define abutments for the sliding of the cover 101 and thus to define the active position and the inactive position of the cover 101.

Furthermore, this makes it possible to actually hold the cover 101 in place with respect to the chamber 2 and to the plate 102.

Thus, a risk is limited that the cover 101 vibrates relative to the lid 7, in particular on an axis orthogonal to the line of vision 10 of the optical sensor 8.

In addition, the flexibility of the tabs 128 carrying the male members 109, 111 contributes to limiting the transmission of the vibrations of the chamber 2 to the cover 101, in particular, in the line of vision 10.

Preferably, the reinforcement 18 is shaped, such that its sides form a first abutment for a first side of the protection 103 in the active position and a second abutment for a second side of the protection 103 in its inactive position.

Preferably, also, the hole 17 is shaped such that its sides form a first abutment for a first side of the strip 104 in the active position and a second abutment for a second side of the strip 104 in its inactive position.

Naturally, the invention is not limited to the embodiment described, but covers any variant coming within the scope of protection of the invention, such as defined by the claims.

In particular, at least one male member can be carried by the cover and at least one corresponding female member by the plate.

The shutter can be otherwise fixed to the chamber, which has been indicated, and for example, by screw-nut assemblies.

Although, in this case, the shutter is fixed to the chamber, the shutter can be made of one part with the chamber. The plate can thus be integrally formed with the chamber. For example, the securing portion can be integrally formed with the chamber.

In any case, the shutter will preferably comprise a portion for securing to the chamber (made of one single part with the chamber or fixed to the chamber) and an engaging portion, preferably extending into a different plane than the securing portion.

In any case, preferably, the engaging portion will extend between the cover and the chamber.

The electronic equipment can be a piece of equipment other than an electronic casing. The set-top box could be integrated to a television, or actually be located in an appliance offering other functionalities (for example, a games console).

Instead of being integral with the lid, the shutter can be integral with the base.

The opening could be arranged in the base and not in the lid.

The engaging portion can extend parallel or orthogonally to the securing portion.

The handling strip can extend parallel or orthogonally to the protection.

Although, in this case, the optical sensor is arranged, such that its line of vision is inclined upwards (i.e. in the direction of the upper main face), the optical sensor can be arranged, such that its line of vision is inclined downwards (i.e. in the direction of the lower main face) or can be arranged, such that its line of vision extends horizontally. Preferably, the cover will slide in a direction orthogonal to the line of vision of the optical sensor and/or parallel to the support carrying the optical sensor.

The support can be a single plate and not a printed circuit board.

The support can be arranged parallel (and not inclined as what has been proposed) with respect to the flank, wherein the opening is provided and/or the optical sensor can be arranged, such that its line of vision is inclined or orthogonal with respect to one of the main faces of the support.

1. A shutter comprising:
a plate,
a cover comprising a protection and a strip for handling the protection, the cover being capable of being moved relative to the plate between an active position and an inactive position,
at least one male member/female member arranged, one on the plate and the other on the cover, such that the engagement of the male member and of the female member temporarily blocks in position the cover in at least one of its two positions,
wherein the protection comprises a first main face and a second main face, at least one male member or one female member of the pair being arranged on one of said main faces of the protection.

2. The shutter according to claim 1, further comprising a first male member/female member pair to block the cover in a first position and a second male member/female member pair to block the cover in a second position.

3. The shutter according to claim 1, wherein at least one male member is a raised element and at least one female member is a housing moulding the shape of the raised element.

4. The shutter according to claim 3, wherein the raised element is partially hemispherical.

5. The shutter according to claim 1, wherein at least one male member is carried by the plate and at least one female member is carried by the cover.

6. The shutter according to claim 1, wherein at least one tab is provided on the plate, the tab carrying the male member or the female member of the plate.

7. The shutter according to claim 6, wherein the tab is a cutout of the plate.

8. The shutter according to claim 1, wherein the strip is provided with at least one textured zone.

9. The shutter according to claim 1, comprising a flexible fastening portion between the protection and the strip.

10. The shutter according to claim 1, wherein the cover is provided with a visual indicator of at least one of its positions.

11. The shutter according to claim 1, wherein the cover comprises at least one lateral notch.

12. The shutter according to claim 1, wherein the cover comprises at least one guide of its sliding.

13. The shutter according to claim 1, wherein the plate comprises at least one light guide.

14. The shutter according to claim 1, wherein the plate comprises at least one positioner.

15. Electronic equipment comprising:
a chamber,
an optical sensor arranged in the chamber,
the shutter according to claim 1, the shutter being arranged, such that in its active position, it is in front of the optical sensor and in an inactive position, it is offset from the optical sensor.

16. The electronic equipment according to claim 15, wherein the electronic equipment is an electronic casing.

17. The electronic equipment according to claim 16, further comprising a support carrying the optical sensor, the cover being arranged between the chamber and the plate and the plate being arranged between the cover and the support.
